(19) United States
(12) Patent Application Publication
(10) Pub. No.: US 2026/0203552 A1
(43) Pub. Date: Jul. 16, 2026

(54) DYNAMIC ASSESSMENT AND MANAGEMENT METHOD FOR ECOLOGICAL ENVIRONMENT BASED ON SPATIO-TEMPORAL DATA ANALYSIS

(71) Applicant: Fuzhou University, Fuzhou (CN)

(72) Inventor: Juanzhu Liang, Fuzhou (CN)

(21) Appl. No.: 19/448,069

(22) Filed: Jan. 13, 2026

(30) Foreign Application Priority Data
Jan. 14, 2025 (CN) 202510056166.3

(51) Int. Cl. G06N 3/0442

(52) U.S. Cl. CPC G06N 3/0442

(57) ABSTRACT

A dynamic assessment and management method for ecological environment based on spatio-temporal data analysis falls within the technical field of ecological environment monitoring. In the present disclosure, cleaned data are obtained by collecting and cleaning multi-source ecological environment data; and data fusion is performed via spatial interpolation and time series analysis, an ecological quality index (EQI) is calculated, and dynamic change trends are identified. Combined with future change results and management objectives, optimization strategies are formulated and multi-objective optimization algorithms are applied to generate optimal management plans. This method improves the accuracy of ecological environment monitoring and assessment, provides scientific decision-making support for managers, and promotes sustainable development.

### CROSS-REFERENCE TO RELATED APPLICATION

This application claims priority of Chinese Patent Application No. 202510056166.3, filed on Jan. 14, 2025, the entire contents of which are incorporated herein by reference.

### TECHNICAL FIELD

The present disclosure relates to the technical field of ecological environment monitoring, and particularly to a dynamic assessment and management method for ecological environment based on spatio-temporal data analysis.

### BACKGROUND

With the global climate change and the intensification of human activities, the dynamic changes of ecological environment have a profound impact on social and economic development and ecosystem stability. Traditional ecological environment assessment methods usually rely on static data or monitoring data at a single time point, which is difficult to fully reflect the dynamic change characteristics of ecological environment. In addition, the existing methods have shortcomings in data integration, spatio-temporal analysis and dynamic prediction, and cannot effectively support the scientific management and decision-making of ecological environment.

In recent years, with the rapid development of remote sensing technology, geographic information system (GIS) and big data analysis technology, the dynamic assessment of ecological environment based on spatio-temporal data has become possible. However, how to efficiently integrate, analyze and model multi-source spatio-temporal data and apply the analysis results to ecological environment management is still a technical problem that needs to be solved urgently.

### SUMMARY

To overcome the shortcomings of the related art, an objective of the present disclosure is to provide a dynamic assessment and management method for ecological environment based on spatio-temporal data analysis to provide a comprehensive, dynamic, scientific and operable ecological environment assessment and management method by fusing multi-source data, a dynamic assessment model and an optimization algorithm. The beneficial effects of the present disclosure are not only reflected in the accurate monitoring and assessment of the ecological environment, but also provide scientific decision support tools for managers, which can significantly improve the efficiency and effect of ecological environment protection and help realize the sustainable development of the ecological environment.

To achieve the above objective, the present disclosure adopts the following technical solutions.

The present disclosure provides a dynamic assessment and management method for ecological environment based on spatio-temporal data analysis, including the steps of:
collecting multi-source ecological environment data;
cleaning the multi-source ecological environment data to obtain cleaning data;
performing spatio-temporal data fusion on the cleaned data by adopting a spatial interpolation method and a time series analysis method to obtain a fused spatio-temporal dataset;
inputting the fused spatio-temporal data set into a trained dynamic assessment model to obtain future ecological environment change results;
calculating an ecological quality index (EQI) based on the fused spatio-temporal data set, and identifying a dynamic change trend of the ecological environment for the fused spatio-temporal data set using a spatio-temporal statistical analysis method; and
combining results of future ecological environment changes, the EQI and the dynamic change trend with ecological environment management objectives, formulating optimization strategies, and adopting the multi-objective optimization algorithm to optimize the optimization strategies to generate an optimal management plan.

Preferably, the multi-source ecological environment data include remote sensing image data, meteorological data, ground monitoring data and socio-economic data.

Preferably, the cleaning the multi-source ecological environment data to obtain cleaning data includes the steps of:
grouping the multi-source ecological environment data according to a preset collection period to obtain a plurality of data groups; and calculating a difference coefficient between a current data group and a previous data group in sequence;
determining whether a value of the difference coefficient is within a preset range;
removing the corresponding data group if the value of the difference coefficient is not within the preset range; and
reserving the corresponding data group until all the data groups are traversed to obtain the cleaning data if the value of the difference coefficient is within a preset range.

Preferably, a calculation formula of the difference coefficient is as follows:

$${P}_{X , Y} = \frac{cov ( X , Y )}{{a}_{X} {β}_{Y}}$$

where P_{X,Y} is a difference coefficient, cov(X, Y) represents a covariance between a current data group X and a previous data group Y, a_{X} represents a mean value of the current data group X, and β_{Y} represents a mean value of the previous data group Y.

Preferably, the performing spatio-temporal data fusion on the cleaned data by adopting a spatial interpolation method and a time series analysis method to obtain a fused spatio-temporal dataset includes the steps of:
unifying the cleaning data into a standard spatio-temporal grid format, and adding a time stamp and a spatial coordinate to each data point in the spatio-temporal grid;
performing spatial interpolation on the data of each time point in the spatio-temporal grid based on the Kriging interpolation method to generate complete spatial distribution data;
performing time series analysis on the data of each spatial position in the spatial distributed data to fill in missing values in time and smooth time series to obtain time analysis data; and
performing spatio-temporal data fusion on the spatial distribution data and the time analysis data to obtain the fused spatio-temporal data set.

Preferably, the performing time series analysis on the data of each spatial position in the spatial distributed data to fill in missing values in time and smooth time series to obtain time analysis data, including the steps of:
extracting time series on the data of each spatial position; and
performing prediction and interpolation on the time series according to the long short-term memory (LSTM) network, filling missing values in time intervals, and smoothing fluctuations of the time series to obtain the time analysis data;
Preferably, the dynamic assessment model is a convolutional neural network (CNN)-LSTM combination model.

Preferably, a calculation formula of the EQI is as follows:

$$EQI = {w}_{1} \cdot NDVI + {w}_{2} \cdot AQI + {w}_{3} \cdot WQI + {w}_{4} \cdot LUI + {w}_{5} \cdot SEI$$

where EQI ranges from 0 to 1, and a higher value indicates better ecological environment quality; NDVI is a normalized difference vegetation index (NDVI), reflecting vegetation coverage; AQI is an air quality index (AQI), reflecting the degree of air pollution; WQI is a water quality index (WQI), reflecting the degree of water pollution; LUI is a land use intensity (LUI) index, reflecting the intensity of human activities on land resources; SEI is a social-economic index (SEI), reflecting the impact of social-economic development on the ecological environment; and w₁, w₂, w₃, w₄ and w₅ are weight coefficients, representing the relative importance of each index to the ecological environment quality, which satisfy w₁+w₂+w₃+w₄+w₅=1.

Preferably, the spatio-temporal statistical analysis method is the Mann-Kendall trend test method.

Preferably, the multi-objective optimization algorithm is a particle swarm optimization algorithm.

According to the specific examples provided by the present disclosure, the present disclosure has the following technical effects.

The present disclosure provides a dynamic assessment and management method for ecological environment based on spatio-temporal data analysis, including the steps of: collecting multi-source ecological environment data; cleaning the multi-source ecological environment data to obtain cleaning data; performing spatio-temporal data fusion on the cleaned data by adopting a spatial interpolation method and a time series analysis method to obtain a fused spatio-temporal dataset; inputting the fused spatio-temporal data set into a trained dynamic assessment model to obtain future ecological environment change results; calculating an EQI based on the fused spatio-temporal data set, and identifying a dynamic change trend of the ecological environment for the fused spatio-temporal data set using a spatio-temporal statistical analysis method; and combining results of future ecological environment changes, the EQI and the dynamic change trend with ecological environment management objectives, formulating optimization strategies, and adopting the multi-objective optimization algorithm to optimize the optimization strategies to generate an optimal management plan. The present disclosure provides a comprehensive, dynamic, scientific and operable ecological environment assessment and management method by fusing multi-source data, a dynamic assessment model and an optimization algorithm. The beneficial effects of the present disclosure are not only reflected in the accurate monitoring and assessment of the ecological environment, but also provide scientific decision support tools for managers, which can significantly improve the efficiency and effect of ecological environment protection and help realize the sustainable development of the ecological environment.

### BRIEF DESCRIPTION OF THE DRAWINGS

To explain the technical solutions of examples in the present disclosure or in the related art more clearly, the accompanying drawings required in the description of the examples are introduced briefly below. Obviously, the drawings in the following description are only some examples of the present disclosure, and other drawings can be obtained according to these drawings without creative efforts for those ordinary skilled in the art.

FIG. 1 is a flowchart of a method according to an example of the present disclosure.

### DETAILED DESCRIPTION

Technical solutions in the examples of the present disclosure will be described clearly and completely in the following with reference to the accompanying drawings in the examples of the present disclosure. Obviously, all the described examples are only some, rather than all examples of the present disclosure. Based on the examples in the present disclosure, all other examples obtained by those ordinary skilled in the art without creative efforts belong to the protection scope of the present disclosure.

An objective of the present disclosure is to provide a dynamic assessment and management method for ecological environment based on spatio-temporal data analysis to provide a comprehensive, dynamic, scientific and operable ecological environment assessment and management method by fusing multi-source data, a dynamic assessment model and an optimization algorithm. The beneficial effects of the present disclosure are not only reflected in the accurate monitoring and assessment of the ecological environment, but also provide scientific decision support tools for managers, which can significantly improve the efficiency and effect of ecological environment protection and help realize the sustainable development of the ecological environment.

To make the above objectives, characteristics and advantages of the present disclosure more obvious and understandable, the present disclosure is further explained in detail in combination with the accompanying drawings and specific embodiments.

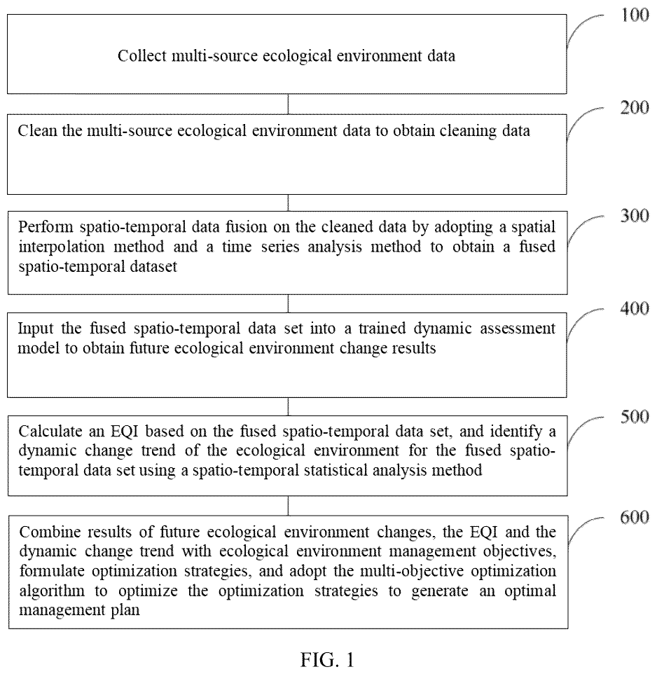

FIG. 1 is a flowchart of a method according to an example of the present disclosure. As shown in FIG. 1, the present disclosure provides a dynamic assessment and management method for ecological environment based on spatio-temporal data analysis, including the following steps.

In step 100: multi-source ecological environment data are collected.

In step 200: multi-source ecological environment data are cleaned to obtain cleaning data.

In step 300: spatio-temporal data fusion is performed on the cleaned data by adopting a spatial interpolation method and a time series analysis method to obtain a fused spatio-temporal dataset.

In step 400: the fused spatio-temporal data set is inputted into a trained dynamic assessment model to obtain future ecological environment change results.

In step 500: an EQI is calculated based on the fused spatio-temporal data set, and a dynamic change trend of the ecological environment for the fused spatio-temporal data set is identified using a spatio-temporal statistical analysis method.

In step 600: results of future ecological environment changes, the EQI and the dynamic change trend are combined with ecological environment management objectives, optimization strategies are formulated, and the multi-objective optimization algorithm is adopted to optimize the optimization strategies to generate an optimal management plan.

Preferably, the multi-source ecological environment data include remote sensing image data, meteorological data, ground monitoring data and socio-economic data.

Specifically, step 100 in this example includes the following steps.

### In Step 101: Remote Sensing Image Data Collection

Remote sensing image data are acquired via satellite remote sensing platforms (including Landsat, Sentinel, moderate resolution imaging spectroradiometer (MODIS), etc.) or unmanned aerial vehicles (UAVs). The data mainly include multispectral image data reflecting surface characteristics (including red light and near-infrared bands) as well as surface temperature, vegetation cover and other information. In addition, high-resolution or medium-resolution image data are selected according to the specific requirements of the research area to ensure that the data cover the entire target area, and image data within the corresponding time range are downloaded to capture spatio-temporal dynamic changes.

### In Step 102: Meteorological Data Collection

Meteorological data are obtained through meteorological monitoring stations or public meteorological databases (including National Oceanic and Atmospheric Administration (NOAA), European Centre for Medium-Range Weather Forecasts (ECMWF) and National Meteorological Administration), mainly including meteorological parameters such as temperature, precipitation, humidity, wind speed, and air pressure. To ensure the spatio-temporal consistency of the data, the meteorological data consistent with the time range of remote sensing image data are selected, and the corresponding meteorological data subset is extracted according to the geographical range of the target area.

### In Step 103: Ground Monitoring Data Collection

Ground monitoring data are obtained through environmental monitoring data provided by monitoring stations or relevant institutions in the target area, mainly including air quality (such as particulate matter with an aerodynamic diameter of 2.5 micrometers or less (PM2.5), PM10 and sulfur dioxide (SO₂) concentration), water quality parameters (such as dissolved oxygen, chemical oxygen demand and total phosphorus concentration) and soil quality. In the collection process, attention is paid to the spatial distribution of data to ensure that the coverage of monitoring stations can reflect the environmental conditions of the entire target area.

### In Step 104: Socio-Economic Data Collection

Socio-economic data are obtained via government statistical yearbooks, public databases (such as World Bank (WB) and United Nations Development Programme (UNDP)), or regional economic surveys, and mainly include information such as population density, gross domestic product (GDP), land use types, and the intensity of industrial and agricultural activities. During data collection, high spatial resolution of the data (such as county-level or township-level) is ensured, and key indicators that can reflect the impact of socio-economic activities on the ecological environment are selected to provide support for subsequent dynamic assessment of the ecological environment.

Through the collection of the above four types of data, a basic data set of multi-source ecological environment data is constructed, which provides a comprehensive and accurate input for subsequent data cleaning, spatio-temporal fusion and dynamic assessment.

Preferably, the cleaning the multi-source ecological environment data to obtain cleaning data includes the following steps.

Multi-source ecological environment data are grouped according to a preset collection period to obtain a plurality of data groups.

A difference coefficient between a current data group and a previous data group is calculated in sequence.

Whether a value of the difference coefficient is within a preset range is determined.

The corresponding data group is removed if the value of the difference coefficient is not within the preset range.

The corresponding data group is reserved until all the data groups are traversed to obtain the cleaning data if the value of the difference coefficient is within a preset range.

Preferably, a calculation formula of the difference coefficient is as follows:

$${P}_{X , Y} = \frac{cov ( X , Y )}{{a}_{X} {β}_{Y}}$$

where P_{X,Y} is a difference coefficient, cov(X, Y) represents a covariance between a current data group X and a previous data group Y, a_{X} represents a mean value of the current data group X, and β_{Y} represents a mean value of the previous data group Y.

Specifically, step 200 in this example includes the following steps.

### In Step 201: Data Grouping

First, the multi-source ecological environment data are grouped according to a preset collection period (such as daily, weekly or monthly), and the data are divided into a plurality of data groups in time sequence. Each data group includes all data points collected within the period, such as remote sensing image data, meteorological data, ground monitoring data and socio-economic data on a specific day. An objective of grouping is to facilitate consistency analysis of the data in the time series and provide a basis for the subsequent calculation of difference coefficients.

### In Step 202: Difference Coefficient Calculation

For each data group, the difference coefficient between the current data group and the previous data group is calculated in sequence. The similarity between two data groups is measured by the difference coefficient through analyzing the degree of coordinated variation between the two data groups. Specifically, the calculation of the difference coefficient requires consideration of mean values of the two data groups as well as the covariance between the two data groups; the covariance reflects the correlation between the two data groups; and the mean values are used for standardizing the overall level of the data groups. In this way, the degree of difference between the current data set and the previous data set can be quantified.

### In Step 203: Difference Coefficient Range Determination

After the difference coefficient is calculated, the difference coefficient is compared with a preset range. The preset range is usually determined according to actual application scenarios and data characteristics, such as reasonable upper and lower limits are derived through historical data analysis. If the value of the difference coefficient exceeds the preset range, it indicates that there is an abnormal difference between the current data group and the previous data group, which may be caused by data collection error, noise interference or other abnormal conditions; and at this time, the data group needs to be marked as abnormal data.

### In Step 204: Data Group Screening and Cleaning

According to the range determination result of the difference coefficient, the data groups are screened. If the value of the difference coefficient is within the preset range, the current data group is retained and regarded as meeting the data quality requirements; and if the value of the difference coefficient is not within the preset range, the current data group is removed to avoid the impact of abnormal data on subsequent analysis. By traversing all data groups, data groups that meet the quality requirements are gradually screened out, and the cleaned multi-source ecological environment data are obtained ultimately, which provides high-quality input data for subsequent spatio-temporal data fusion and dynamic assessment.

Specifically, after data cleaning, this example performs denoising processing on the reserved data group to further improve the quality and reliability of the data. For remote sensing image data, median filtering or wavelet transform can be used to remove random noise in the image. For meteorological data and ground monitoring data, the moving average method or Kalman filter can be used for smoothing the time series data to eliminate abnormal fluctuations. For socio-economic data, outliers can be identified and eliminated by statistical methods (such as box plot analysis). In a process of denoising, appropriate denoising algorithms are selected according to different data types to ensure the authenticity and integrity of the data.

After the denoising is completed, this example also uniformly converts the multi-source data into a standardized format for subsequent spatio-temporal data fusion and dynamic assessment. For remote sensing image data, remote sensing image data are converted to the geographic tagged image file format (GeoTIFF) format, and the images are subjected to coordinate projection correction. For meteorological data and ground monitoring data, meteorological data and ground monitoring data are stored in time series formats (such as comma-separated values (CSVs) or network common data forms (NetCDFs)), and time stamps and spatial coordinate information are appended to the meteorological data and ground monitoring data. For socio-economic data, socio-economic data are converted to structured table formats (such as Excel or database tables), and standardized naming is applied to the data fields. Through format conversion, all data are ensured to have a consistent time and space reference system, which provides standardized data input for subsequent analysis.

Preferably, the spatio-temporal data fusion being performed on the cleaned data by adopting a spatial interpolation method and a time series analysis method to obtain a fused spatio-temporal dataset includes the following steps.

Cleaning data are unified into a standard spatio-temporal grid format, and a time stamp and a spatial coordinate are added to each data point in the spatio-temporal grid.

Data of each time point in the spatio-temporal grid are subjected to spatial interpolation based on the Kriging interpolation method to generate complete spatial distribution data.

Data of each spatial position in the spatial distributed data are subjected to time series analysis to fill in missing values in time and smooth time series to obtain time analysis data.

Spatial distribution data and the time analysis data are subjected to spatio-temporal data fusion to obtain the fused spatio-temporal data set.

Preferably, the time series analysis being performed on the data of each spatial position in the spatial distributed data to fill in missing values in time and smooth time series to obtain time analysis data includes the following steps.

Time series are extracted from the data of each spatial position.

The time series are subjected to prediction and interpolation according to the LSTM network, missing values in time intervals are filled, and fluctuations of the time series are smoothed to obtain the time analysis data.

Preferably, the dynamic assessment model is a CNN-LSTM combination model.

Specifically, step 300 in this example includes the following steps.

### In Step 301: Standardization and Spatio-Temporal Gridding of Cleaning Data

First, the cleaned multi-source ecological environment data are uniformly converted into a standard spatio-temporal grid format to facilitate spatio-temporal data fusion. Specifically, spatial grids (such as 1 km×1 km grid cells) are divided according to the geographical scope of the research area, and spatial coordinates (latitude and longitude or grid numbers) are added to each grid cell. Meanwhile, data are sorted according to the time dimension, and time stamps (such as YYYY-MM-DD) are added to each data point to ensure that the data have clear spatial and temporal attributes. Through such standardized processing, initial data grids including spatio-temporal coordinates are generated, which provide a basis for subsequent spatial interpolation and time series analysis.

### In Step 302: Spatial Interpolation Based on Kriging Interpolation

For the data at each time point in the spatio-temporal grid, Kriging interpolation method is used for spatial interpolation to generate complete spatial distribution data. Kriging interpolation is a spatial interpolation method based on geostatistics, which can generate high-precision interpolation results according to the spatial correlation of data. In the specific implementation process, firstly, the semivariogram of the data is calculated, spatial correlation models (such as spherical model or Gaussian model) are fitted, and the target grid cell is interpolated. Through Kriging interpolation, spatial data gaps are filled, and complete spatial distribution data at each time point are generated, which provide support for subsequent time series analysis.

### In Step 303: LSTM-Based Time Series Analysis

For each spatial position (i.e., each grid cell) in the spatial distribution data, time series data are extracted, and the time series are subjected to prediction and interpolation by using the LSTM network to fill the missing values in the time dimension and smooth the fluctuations of the time series. The LSTM network is a deep learning model suitable for processing time series data, which can capture the short-term changes and long-term trends of the data. In the specific implementation process, firstly, each time series is normalized; the time series are input into a pre-trained LSTM network for the prediction and interpolation of missing values within time intervals. Meanwhile, abnormal fluctuations in the data are smoothed to generate time analysis data. The application of the LSTM network can effectively improve the accuracy and robustness of time series analysis.

### In Step 304: Application of Spatio-Temporal Data Fusion and Dynamic Assessment Model

Spatio-temporal data fusion is performed on the spatial distribution data generated by Kriging interpolation and the time analysis data obtained based on LSTM time series analysis. In the fusion process, the time series results in the time analysis data are matched with the spatial distribution data according to time stamps and spatial coordinates, and the overlapping parts are subjected to weighted fusion (such as simple average or weighted average). Finally, a complete fused spatio-temporal dataset is generated, which includes the ecological environment attribute values of each time point and spatial position. Subsequently, the fused spatio-temporal dataset is input into the CNN-LSTM combined model for dynamic assessment. Spatial characteristics are extracted by the CNN component, time series characteristics are captured by the LSTM component, and prediction results of future ecological environment changes are obtained, which provide a scientific basis for subsequent optimal management strategies.

Further, the time series analysis based on LSTM in this example is as follows.

For each spatial position (i.e., each grid cell) in the spatial distribution data, time series are extracted from the data according to time stamps to form data sequences with time as the dimension. For example, for a specific grid cell, ecological environment attribute values (e.g., NDVI and AQI) at different time points (e.g., daily and monthly) are extracted to form corresponding time series.

The extracted time series data are input into the LSTM model for prediction and interpolation operations. Short-term dynamic changes and long-term trends of time series are captured by the LSTM network through memory units, and missing values within time intervals are predicted. Specifically, the LSTM model learns the patterns of time series through complete historical data in the training phase, and predicts missing values by inputting incomplete time series in the interpolation phase. At the same time, the LSTM model can also smooth out abnormal fluctuations in time series and generate more stable time analysis data.

Further, the CNN-LSTM combination model of the dynamic assessment model is as follows.

CNN is used to extract spatial characteristics from fused spatio-temporal datasets. Specifically, spatial distribution data in spatio-temporal data (such as grid data at each time point) are input into the CNN model, and spatial characteristics, including spatial distribution patterns of ecological environments and hot spots are extracted through convolution operations. The convolution kernel of CNN can capture local spatial characteristics, while the pooling layer can reduce the dimensionality of characteristics and retain key spatial information.

LSTM is used to capture time series characteristics in spatio-temporal data. Spatial characteristics extracted by CNN are input into the LSTM model in time sequence, dynamic change patterns of time series are learned by the LSTM model through memory units, and future change trends of ecological environment are predicted. Spatial and temporal characteristics are captured simultaneously by the combination of CNN and LSTM, which improves the accuracy and prediction capability of the dynamic assessment model.

Through the above steps, this example finally realizes spatio-temporal data fusion of the cleaning data, and generates future ecological environment change results through the CNN-LSTM dynamic assessment model, providing scientific support for subsequent optimization management.

Preferably, a calculation formula of the EQI is as follows:

$$EQI = {w}_{1} \cdot NDVI + {w}_{2} \cdot AQI + {w}_{3} \cdot WQI + {w}_{4} \cdot LUI + {w}_{5} \cdot SEI$$

where EQI ranges from 0 to 1, and a higher value indicates better ecological environment quality; NDVI is an NDVI, reflecting vegetation coverage; AQI is an AQI, reflecting the degree of air pollution; WQI is a WQI, reflecting the degree of water pollution; LUI is an LUI index, reflecting the intensity of human activities on land resources; SEI is an SEI, reflecting the impact of social-economic development on the ecological environment; and w₁, w₂, w₃, w₄ and w₅ are weight coefficients, representing the relative importance of each index to the ecological environment quality, which satisfy w₁+w₂+w₃+w₄+w₅=1.

Exemplarily, based on historical ecological environment data, this example employs a principal component analysis (PCA) method to determine the weight coefficients. Specifically, after standardizing multi-source ecological environment data (NDVI, AQI, WQI, LUI and SEI), the covariance matrix of each index is calculated, and the principal components are extracted. By analyzing the characteristic values and characteristic vectors of each principal component, the contribution rate of each index in the principal component is determined and normalized to the weight coefficient. PCA method can objectively extract the importance of each index from the data, and avoid the influence of human intervention on weight distribution.

Specifically, the future ecological environment change result of this example includes the ecological environment quality change trend and spatial distribution characteristics of the target area within a specific time range in the future (e.g., the next 1 year, 5 years or 10 years), and the specific content includes the predicted value of the EQI, the change trend of each key index (e.g., NDVI, AQI, WQI, LUI and SEI), the dynamic changes of the ecological environment hot spot and cold spot areas, as well as the possible environmental risks (e.g., areas with intensified pollution or ecological degradation) and improvement areas (e.g., areas with vegetation restoration or water quality improvement). These results provide scientific basis and forward-looking guidance for ecological environment protection and management.

Preferably, the spatio-temporal statistical analysis method is the Mann-Kendall trend test method.

Specifically, step 500 in this example includes the following steps.

### In Step 501: Calculation of EQI

Firstly, based on the fused spatio-temporal dataset, key indicator data of each grid cell at different time points are extracted, including NDVI, AQI, WQI, LUI and SEI. These indicators are subjected to normalization processing, and the values are converted into the same range (e.g., 0 to 1) to facilitate unified calculation. According to the predetermined weight coefficients, the indicators are weighted and summed according to the relative importance to ecological environment quality, and the EQI of each grid cell at different time points is calculated. The calculation results of EQI can reflect the spatial and temporal distribution of ecological environment quality in the target area.

### In Step 502: Preparation of Mann-Kendall Trend Test

After the EQI of each grid cell is calculated, its time series data is extracted to form the EQI time series of each grid cell. The Mann-Kendall trend test is a non-parametric statistical method suitable for analyzing the change trends of time series data, and the assumption of data distribution characteristics is not required. To perform the test, the EQI time series of each grid cell are arranged in time sequence, and the statistical parameters required for the test (e.g., time series length and data values) are prepared.

### In Step 503: Implementation of Mann-Kendall Trend Test

The Mann-Kendall trend test is performed on the EQI time series of each grid cell to determine whether its change trend is significantly increasing, significantly decreasing, or showing no significant change. Specifically, the test method calculates the trend statistic by comparing the magnitude relationship of data points in the time series, and the significance of the trend is determined in combination with the significance level (e.g., 0.05 or 0.01). The test results can be labeled as “increasing trend”, “decreasing trend” or “no significant trend”, and such trend information is associated with the spatial coordinates of the grid cells.

### In Step 504: Spatial Visualization and Analysis of Dynamic Change Trends

The results of the Mann-Kendall test are mapped to the spatial grid of the target area, and a spatial distribution map of ecological environment quality change trends is generated. For example, different colors are used to represent areas with increasing trends, decreasing trends and no significant trends to intuitively display the dynamic change trends of ecological environment quality. In addition, combined with hotspot analysis methods, key areas of ecological environment change (e.g., significantly improved areas or degraded areas) are identified, which provide scientific basis and decision support for ecological environment protection and management.

Preferably, the multi-objective optimization algorithm is a particle swarm optimization algorithm.

Specifically, step 600 in this example includes the following steps.

### In Step 601: Formulation of Optimization Objectives and Constraints

Based on the future ecological environment change results, EQI and dynamic change trends, combined with ecological environment management objectives, the objective function and constraints for optimization are clarified. Optimization objectives can include the improvement of EQI (e.g., EQI maximization), pollution reduction (e.g., AQI minimization), water quality improvement (e.g., WQI maximization), and reduction of LUI (e.g., LUI minimization). Constraints are set according to actual conditions, such as budget limitations, land use planning requirements and socio-economic development goals. Clear objectives and constraints provide a clear direction for subsequent optimization calculations.

### In Step 602: Initialization of Particle Swarm and Parameter Setting

Particle swarm optimization (PSO) algorithm is used for optimization, and the particle swarm is initialized first. Each particle in the particle swarm represents a potential ecological environment management strategy, and its position indicates the specific parameter values of the strategy (e.g., pollution control investment and vegetation restoration area). During initialization, the positions and velocities of the particle swarm are randomly generated, and the key parameters of PSO are set, including size of the particle swarm, maximum number of iterations, inertia weight and acceleration factors. The rational setting of these parameters can affect the convergence speed and optimization effect of the algorithm.

### In Step 603: Design and Calculation of Fitness Function

A fitness function is designed for each particle to assess the pros and cons of its corresponding management strategy. The fitness function is designed according to the optimization objectives and constraints, such as comprehensive consideration of the improvement range of EQI, the reduction of pollutants, and the control of economic costs. For each particle, its position (i.e., management strategy parameters) is substituted into the fitness function for calculation, and the fitness value is obtained. A higher fitness value indicates that the management strategy corresponding to the particle is closer to the optimization objective.

### In Step 604: Iterative Optimization of Particle Swarm

In each iteration, the velocity and position of each particle are updated according to the fitness values of the particle swarm. The position update of particles follows the core mechanism of PSO, i.e., the direction is adjusted under the guidance of the global optimal solution and individual optimal solution, and the exploration and development capabilities of particles are controlled in combination with inertia weight. Through multiple iterations, the particle swarm gradually converges to the global optimal solution, and the optimal management strategy that meets the optimization objectives and constraints is found.

### In Step 605: Generation of Optimal Management Plan

When the particle swarm reaches the maximum number of iterations or meets the convergence conditions, the algorithm stops running, and the global optimal solution is output. The particle position corresponding to the optimal solution is the parameter values of the optimal management plan, such as specific measures of pollution control, area allocation for vegetation restoration and optimal planning of land use. Combined with these parameter values, a specific ecological environment management plan is generated, and the optimization results are displayed through visualization tools, which provide scientific basis and implementation guidance for decision-makers. The final management plan can meet the ecological environment management objectives while balancing the multiple demands of economy, society and environment to realize the sustainable development of ecological environment.

The present disclosure has the following advantageous effects.
(1) In the present disclosure, multi-source ecological environment data (remote sensing image data, meteorological data, ground monitoring data and socio-economic data) are integrated. Data cleaning, denoising and format conversion are performed to ensure data quality and consistency to comprehensively reflect the multi-dimensional characteristics of the ecological environment. Through the calculation of the EQI, multiple key factors such as vegetation, air, water quality, land use and socio-economy are comprehensively considered, enabling the overall assessment of ecological environment quality status.
(2) In the present disclosure, spatial interpolation methods and time series analysis methods are adopted for spatio-temporal data fusion of cleaned data, which can dynamically capture the spatio-temporal variation characteristics of the ecological environment and make up for the deficiencies of static assessment in traditional methods. Through spatio-temporal statistical analysis methods (e.g., spatio-temporal hotspot analysis and trend analysis), the dynamic variation trends of the ecological environment can be identified, and ecological environment hotspots, coldspots and potential problem areas are discovered, providing a scientific basis for management.
(3) In the present disclosure, the trained dynamic assessment model is utilized to analyze the fused spatio-temporal dataset, which can predict future ecological environment change trends, identify potential environmental risk areas or improvement areas in advance, and support forward-looking decision-making. Through the prediction results, more accurate time windows and spatial guidance can be provided for ecological protection and restoration.
(4) In the present disclosure, optimization strategies are formulated based on future ecological environment change results, EQI and dynamic variation trends, and optimal management plans are generated by multi-objective optimization algorithms, ensuring the scientificity and efficiency of ecological environment management. Multi-objective optimization algorithms can find a balance among ecological protection, resource utilization and socio-economic development, realizing the sustainable management of the ecological environment.
(5) In the present disclosure, the final achievements include optimal management plans and visual display, facilitating decision-makers to intuitively understand the ecological environment status and its variation trends, and supporting scientific decision-making. By delimiting ecological restoration priority areas, optimizing resource allocation plans and providing targeted policy recommendations, the operability and implementation efficiency of management measures are improved.
(6) In the present disclosure, the framework has strong adaptability. Data sources, weight coefficients and optimization objectives can be adjusted according to the ecological environment characteristics and management objectives of different regions, making it applicable to various ecological environment assessment and management scenarios. The dynamic assessment model and optimization algorithm can be updated and expanded according to actual demands to adapt to complex and changing ecological environment problems.
(7) In the present disclosure, managers are assisted to quickly identify problem areas in the ecological environment (e.g., pollution hotspots and degraded areas), prioritize targeted restoration measures, and improve the accuracy and efficiency of ecological protection. Through dynamic monitoring and prediction, a scientific basis can be provided for the formulation of ecological environment protection policies, helping to realize the sustainable development of the ecological environment.
(8) In the present disclosure, through the optimization of resource allocation and formulation of scientific management strategies, resource waste is reduced, and the input-output ratio of ecological restoration and environmental protection is improved. Multi-objective optimization algorithms can maximize benefits under the condition of limited resources, providing an economical and efficient solution for ecological environment management.

Each example in this specification is described in a progressive manner, and each example focuses on the differences from other examples. The same and similar parts of each example can be referred to each other.

While the principles and embodiments of the present disclosure have been described herein using specific examples, the description of the above examples is intended only to aid in the understanding of the method and core idea of the present disclosure. Meanwhile, for those skilled in the art, according to the idea of the present disclosure, changes will occupy a place in the specific embodiments and application ranges. In view of the above, this specification is not to be construed as limiting the present disclosure.

1. A dynamic assessment and management method for ecological environment based on spatio-temporal data analysis, comprising the steps of:
collecting multi-source ecological environment data;
cleaning the multi-source ecological environment data to obtain cleaning data;
performing spatio-temporal data fusion on the cleaned data by adopting a spatial interpolation method and a time series analysis method to obtain a fused spatio-temporal dataset, specifically comprising the steps of: unifying the cleaning data into a standard spatio-temporal grid format, and adding a time stamp and a spatial coordinate to each data point in the spatio-temporal grid; performing spatial interpolation on the data of each time point in the spatio-temporal grid based on the Kriging interpolation method to generate complete spatial distribution data; performing time series analysis on the data of each spatial position in the spatial distributed data to fill in missing values in time and smooth time series to obtain time analysis data; and performing spatio-temporal data fusion on the spatial distribution data and the time analysis data to obtain the fused spatio-temporal data set;
the performing time series analysis on the data of each spatial position in the spatial distributed data to fill in missing values in time and smooth time series to obtain time analysis data, comprising the steps of: extracting time series on the data of each spatial position, performing prediction and interpolation on the time series according to the long short-term memory (LSTM) network, filling missing values in time intervals, and smoothing fluctuations of the time series to obtain the time analysis data;
inputting the fused spatio-temporal data set into a trained dynamic assessment model to obtain future ecological environment change results;
calculating an ecological quality index (EQI) based on the fused spatio-temporal data set, and identifying a dynamic change trend of the ecological environment for the fused spatio-temporal data set using a spatio-temporal statistical analysis method; and
combining results of future ecological environment changes, the EQI and the dynamic change trend with ecological environment management objectives, formulating optimization strategies, and adopting the multi-objective optimization algorithm to optimize the optimization strategies to generate an optimal management plan.

2. The dynamic assessment and management method for ecological environment based on spatio-temporal data analysis according to claim 1, wherein the multi-source ecological environment data comprise remote sensing image data, meteorological data, ground monitoring data and socio-economic data.

3. The dynamic assessment and management method for ecological environment based on spatio-temporal data analysis according to claim 1, wherein the cleaning the multi-source ecological environment data to obtain cleaning data comprises the steps of:
grouping the multi-source ecological environment data according to a preset collection period to obtain a plurality of data groups;
calculating a difference coefficient between a current data group and a previous data group in sequence;
determining whether a value of the difference coefficient is within a preset range;
removing the corresponding data group if the value of the difference coefficient is not within the preset range; and
reserving the corresponding data group until all the data groups are traversed to obtain the cleaning data if the value of the difference coefficient is within a preset range.

4. The dynamic assessment and management method for ecological environment based on spatio-temporal data analysis according to claim 3, wherein a calculation formula of the difference coefficient is as follows:
$${P}_{X , Y} = \frac{cov ( X , Y )}{{a}_{X} {β}_{Y}}$$
where P_{X,Y} is a difference coefficient, cov(X, Y) represents a covariance between a current data group X and a previous data group Y, a_{X} represents a mean value of the current data group X, and β_{Y} represents a mean value of the previous data group Y.

5. The dynamic assessment and management method for ecological environment based on spatio-temporal data analysis according to claim 1, wherein the dynamic assessment model is a convolutional neural network (CNN)-LSTM combination model.

6. The dynamic assessment and management method for ecological environment based on spatio-temporal data analysis according to claim 1, wherein a calculation formula of the EQI is as follows:
$$EQI = {w}_{1} \cdot NDVI + {w}_{2} \cdot AQI + {w}_{3} \cdot WQI + {w}_{4} \cdot LUI + {w}_{5} \cdot SEI$$
where EQI ranges from 0 to 1, and a higher value indicates better ecological environment quality; NDVI is a normalized difference vegetation index (NDVI), reflecting vegetation coverage; AQI is an air quality index (AQI), reflecting the degree of air pollution; WQI is a water quality index (WQI), reflecting the degree of water pollution; LUI is a land use intensity (LUI) index, reflecting the intensity of human activities on land resources; SEI is a social-economic index (SEI), reflecting the impact of social-economic development on the ecological environment; and w₁, w₂, w₃, w₄ and w₅ are weight coefficients, representing the relative importance of each index to the ecological environment quality, which satisfy w₁+w₂+w₃+w₄+w₅=1.

7. The dynamic assessment and management method for ecological environment based on spatio-temporal data analysis according to claim 1, wherein the spatio-temporal statistical analysis method is the Mann-Kendall trend test method.

8. The dynamic assessment and management method for ecological environment based on spatio-temporal data analysis according to claim 1, wherein the multi-objective optimization algorithm is a particle swarm optimization algorithm.
